(19) United States
(12) Patent Application Publication
(10) Pub. No.: US 2004/0242241 A1
(43) Pub. Date: Dec. 2, 2004

(54) Method for providing calling party location information

(76) Inventors: Thomas Dale Strom, Naperville, IL (US); Harinath R. Rachapalli, Woodridge, IL (US)

Correspondence Address: Richard J. Minnich, Fay, Sharpe, Fagan, Minnich & McKee, LLP, Seventh Floor, 1100 Superior Avenue, Cleveland, OH, 44114, US

(21) Appl. No.: 10/449,040

(22) Filed: May 30, 2003

(51) Int. Cl. H04M 3/42

(52) U.S. Cl. 455/456.3; 455/456.1; 455/415

(57) ABSTRACT

A system and method of providing wireless calling party location information during call set-up is provided. The method includes determining whether previously collected calling party location information is current and transmitting the previously collected calling party location information when the previously collected calling party location information is current. The method also includes collecting fresh calling party location information and transmitting the fresh calling party location information when the previously collected calling party location information is not current.

### BACKGROUND

The present invention relates to a system and method of providing calling party location information in a wireless communications network and more particularly to a system and method for reducing the burden on system resources when using calling party location information while ensuring that current calling party location information is used.

With the prevalent use of mobile wireless terminals, also known as mobiles, cellular phones, etc., the calling party is free to move around not only in their home system but also to roam using other wireless communications networks in different locations. When a called party receives a call from a calling party the called party may be interested in receiving information about the location of the calling party. As a result of this mobility, it has become especially desirable to obtain the location information about the calling party.

The calling party location information can be determined and collected in a variety of known ways with a variety of different amounts of accuracy. For example, referring to FIG. 1, the location of a wireless terminal 12 used in a wireless communications network 10 can be determined by the Mobile Switching Center (MSC) 14 serving the wireless terminal. The wireless terminal communicates with the network 10 using one or more base stations 16. The general location of the wireless terminal 12 can be determined using messages coming to the serving MSC 14 from the base station 16a nearest the wireless terminal 12. Greater accuracy can be determined by triangulating on the wireless terminals using a plurality of base stations 16a and 16b.

Determining the calling party location information requires the use of network system resources. Generally, the greater the accuracy of the location information the more system resources are required. Further, more system resources are used as location information is used for more and more wireless terminals. As a result, it is desirable to provide calling party location information while conserving network system resources.

### SUMMARY OF THE INVENTION

According to the present invention, a method of providing wireless calling party location information during call set-up is provided.

In accordance with a first aspect of the invention, the method includes determining whether previously collected calling party location information is current, and collecting fresh calling party location information when the previously collected calling party location information is not current.

In accordance with another aspect of the invention, the method includes transmitting the previously collected calling party location information when the previously collected calling party location information is current,

In accordance with another aspect of the invention, the method includes transmitting the fresh calling party location information when the previously collected calling party location information is not current.

In accordance with another aspect of the invention, the method includes providing a calling party location information timestamp indicating the time the previously collected calling party location information was determined.

In accordance with another aspect of the invention, the method includes determining the age of the previously collected calling party location information, wherein the age is the duration of time between the timestamp with the time of the call setup.

In accordance with another aspect of the invention, the method includes comparing the age of the previously collected calling party location information with an age window. The previously collected calling party location information is current if the age of the previously collected calling party location information falls within the age window. The previously collected calling party location information is not current if the age of the previously collected calling party location information does not fall within the age window.

Other features, benefits and advantages of this invention will become apparent to those skilled in the art from the following detailed description of the preferred embodiments, when read in light of the accompanying drawings.

### BRIEF DESCRIPTION OF THE DRAWINGS

The invention may take form in certain components and structures, preferred embodiments of which will be illustrated in the accompanying drawings wherein:

FIG. 1 illustrates a prior art system for determining calling party location information;

FIG. 2 illustrates a communications system in accordance with the invention;

FIG. 3 illustrates a method of providing fresh calling party location information in accordance with the invention;

FIG. 4 illustrates a method of determining whether previously collected calling party location information is current.

### DETAILED DESCRIPTION OF THE INVENTION

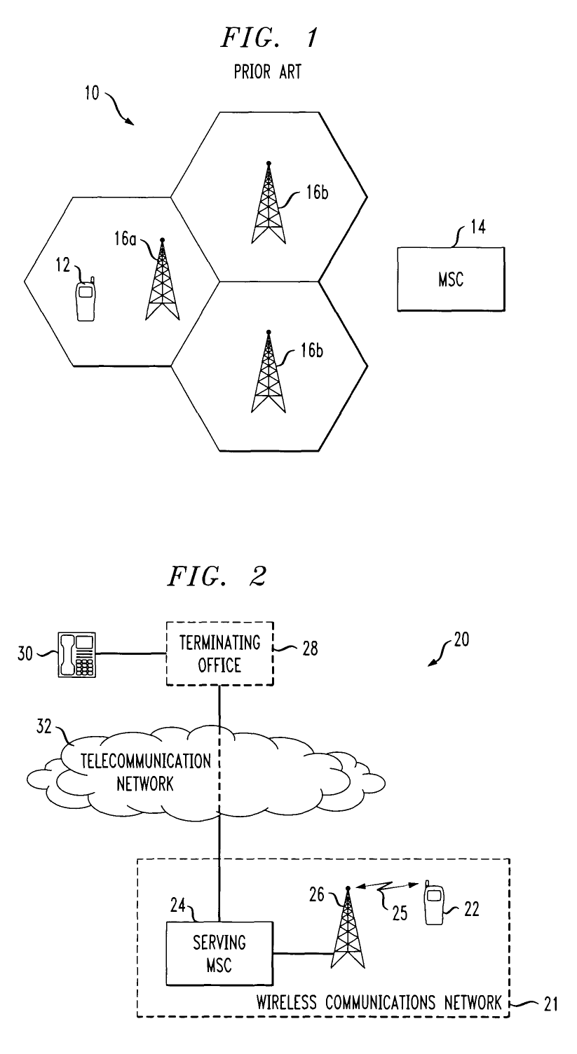

Referring now to FIG. 2, a portion of a communications network is shown generally at 20. The communications network 20 includes a wireless communications network shown at 21. The wireless communications network 21 can be any suitable known wireless communications network including but not limited to CDMA, GSM, etc. The wireless communications network 21 includes a wireless mobile terminal 22, also referred to herein as the calling party, communicating with a base station 26 over an air interface 25. The wireless communications network 21 also includes a serving MSC 24 communicating with the base station 26 in any suitable known manner. The serving MSC is the MSC handling the communications of the wireless mobile terminal 22 with the communications network 20 and handles call set-ups for calls made by the wireless mobile terminal 22. The serving MSC and be the mobile wireless terminal's home MSC or a different MSC if the mobile wireless terminal is roaming.

The communications network 20 also includes a terminating office 28 communicating with the serving MSC 24 using any suitable know connection. The terminating office 28 is connected to a terminating party 30, also known as the called party, in any suitable known manner. The calling party 22 calls the terminating party 30. The terminating party can be communicating with the calling party using any known telecommunications network 32, including but not limited to a wireless network or a wireline network, an Internet Protocol (IP) network, etc.

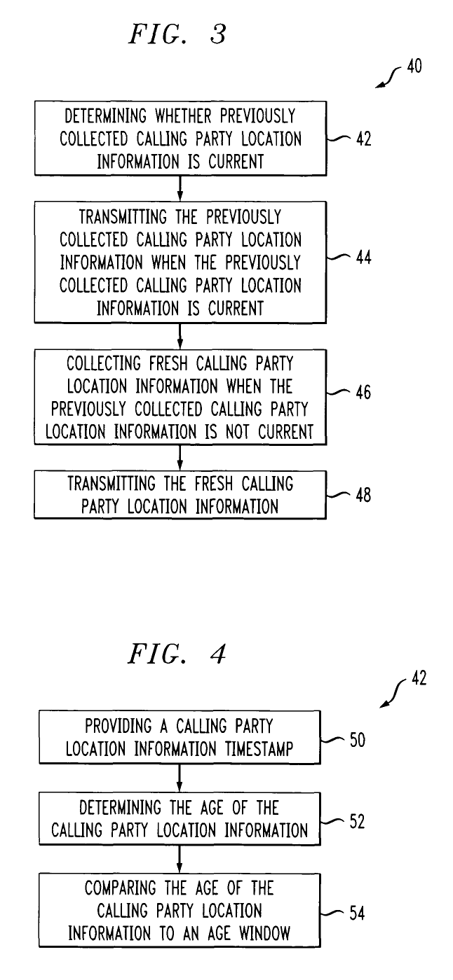

Referring now to FIG. 3, a method of providing wireless calling party location information during call set-up is shown generally at 40. The calling party location information can be determined and collected in any suitable known manner. The term “collecting” as used herein can also include determining so that collecting calling party location information can include determining the calling party location information.

The method includes determining whether previously collected calling party location information is current at 42. The previously collected calling party location information was collected previous to the call set-up. It could have been collected any time before the call set-up. The determining step 42 can be performed in any suitable manner, an example of which shall be described in further detail below.

The method also includes at 44 transmitting the previously collected calling party location information when the previously collected calling party location information is current as determined at step 42. The previously collected calling party location information can be transmitted to the terminating office 28 in any suitable known manner, typically by the serving MSC 24. The terminating office 28 can transmit the location information to the called party 30 in any suitable manner. The previously collected calling party location information can be transmitted, such as by the serving MSC 24, during call set-up. It can be transmitted in the first message of call set-up or any other suitable message of call set-up.

The method also includes at 46 collecting fresh calling party location information when the calling party location information is not current as determined at step 42. The fresh calling party location information can be collected in any suitable known manner. Typically, the fresh calling party information is collected by the serving MSC 24, though it can be collected in any other suitable known manner and communicated to the serving MSC 24 in any known manner.

The method also includes at 48 transmitting the fresh calling party location information from the originating office 24 to the terminating office 28. Typically the serving MSC transmits the fresh calling party location information in any suitable known manner, though any other suitable network element can transmit it. The terminating office typically transmits the fresh calling party location information to the called party 30 in any suitable known manner. The fresh calling party location information can be transmitted, such as by the serving MSC 24, during call set-up. It can be transmitted in the first message of call set-up or any other suitable message of call set-up.

Referring now to FIG. 4, an example of the determining step 24 is shown. The step of determining whether previously collected calling party location information is current 42 can include providing a calling party location information timestamp at 50. The time stamp can be generated at the time the previously collected calling party location information is collected/determined. The time stamp can be generated in any suitable known of generating a timestamp manner.

The step of determining whether previously collected calling party location information is current 42 can also include determining the age of the calling party location information at 52. The age of the previously collected calling party location information can be determined using the timestamp and comparing the timestamp with the time of the call set-up. The age is the duration of time between the timestamp and the time of the call setup. The age of the previously collected calling party location information can be determined at step 42 by the serving MSC 24 or by any other suitable network element.

The step of determining whether previously collected calling party location information is current 42 can also include comparing the age of the calling party location information to an age window to at 54. The previously collected calling party location information is current if the age of the previously collected calling party location information falls within the age window. For example if the age of the previously collected calling party location information is 15 minutes and the age window is 20 minutes, the previously collected calling party location information falls within the age window and is current.

The previously collected calling party location information is not current if the age of the previously collected calling party location information does not fall within the age window. For example if the age of the previously collected calling party location information is 20 minutes and the age window is 15 minutes, the previously collected calling party location information does not fall within the age window and is not current. The step of determining whether previously collected calling party location information is current 42 can be performed by the serving MSC 24 or any other suitable network element.

The age window parameter can be determined by the calling party, such as for example dialing a code such as *72 and entering the desired age limit, or in any other suitable known manner such that the age window in the subscriber's profile at the HLR is updated. Alternatively, the age window can be determined by the service provider.

The age window parameter can be stored in the user profile in the calling party's Home Location Register (not shown) and transmitted to the serving MSC 24 during registration, as part of the subscriber profile. The HLR could be an Integrated HLR or a Standalone HLR. Alternately, the age window could be provisioned on a per MSC basis, in which case it is not part of the subscriber profile at the HLR.

The invention conserves system computing resources by not requiring that the calling party location information be re-determined if it has been collected/determined recently. When the calling party location information is transmitted for many calls during call set-up, this can save valuable system computing resources. This can also reduce the time required to set-up calls.

The invention has been described with reference to preferred embodiments. Obviously, modifications and alterations will occur to others upon reading and understanding the preceding specification. It is intended that the invention be construed as including all such modifications and alterations insofar as they come within the scope of the appended claims or the equivalents thereof.

We claim:

1. A method of providing wireless calling party location information during call set-up comprising:
determining whether previously collected calling party location information is current; and
collecting fresh calling party location information when the previously collected calling party location information is not current.

2. The method defined in claim 1 further comprising:
transmitting the previously collected calling party location information when the previously collected calling party location information is current;

3. The method defined in claim 2 wherein the step of transmitting the previously collected calling party location information comprises:
transmitting the previously collected calling party location information to a terminating office.

4. The method defined in claim 2 wherein the step of transmitting the previously collected calling party location information comprises:
transmitting the previously collected calling party location information to a called party.

5. The method defined in claim 1 further comprising:
transmitting the fresh calling party location information.

6. The method defined in claim 5 wherein the step of transmitting the fresh calling party location information comprises:
transmitting the fresh calling party location information to a terminating office.

7. The method defined in claim 5 wherein the step of transmitting the fresh calling party location information comprises:
transmitting the fresh calling party location information to a called party.

8. The method defined in claim 1 wherein the determining step comprises:
providing a calling party location information timestamp indicating the time the previously collected calling party location information was collected.

9. The method defined in claim 8 wherein the determining step further comprises:
determining the age of the previously collected calling party location information, wherein the age is the duration of time between the timestamp with the time of the call setup.

10. The method defined in claim 9 wherein the step of determining whether the previously collected calling party location information is current farther comprises:
comparing the age of the previously collected calling party location information with an age window; wherein the previously collected calling party location information is current if the age of the previously collected calling party location information falls within the age window and the previously collected calling party location information is not current if the age of the previously collected calling party location information does not fall within the age window.

11. The method defined in claim 10 wherein the age window is provisioned on a per calling party basis.

12. The method defined in claim 11 wherein the calling party is a subscriber to location information services.

13. The method defined in claim 11 wherein the calling party can modify the age window.

14. The method defined in claim 10 wherein the age window is provisioned by a service provider.

15. The method defined in claim 14 wherein the age window is provisioned on a per MSC basis.

16. The method defined in claim 2 wherein the previously collected calling party location information is transmitted during call set-up.

17. The method defined in claim 16 wherein the previously collected calling party location information is transmitted in the first call set-up message.

18. The method defined in claim 5 wherein the fresh calling party location information is transmitted during call set-up.

19. The method defined in claim 18 wherein the fresh calling party location information is transmitted in the first call set-up message.
